(19) United States
(12) Patent Application Publication
(10) Pub. No.: US 2024/0304789 A1
(43) Pub. Date: Sep. 12, 2024

(54) SECONDARY BATTERY

(71) Applicant: Prime Planet Energy & Solutions, Inc., Tokyo (JP)

(72) Inventor: Naoto ONODERA, Kobe-shi (JP)

(21) Appl. No.: 18/587,955

(22) Filed: Feb. 27, 2024

(30) Foreign Application Priority Data
Mar. 10, 2023 (JP) 2023-037931

(51) Int. Cl. H01M 4/36; H01M 4/133; H01M 4/134; H01M 4/38; H01M 4/587; H01M 10/0525; H01M 4/02

(52) U.S. Cl. CPC H01M 4/364; H01M 4/133; H01M 4/134; H01M 4/386; H01M 4/587; H01M 10/0525; H01M 2004/021; H01M 2004/027

(57) ABSTRACT

The secondary battery disclosed herein is a secondary battery, including an electrode body having a positive electrode and a negative electrode, wherein the negative electrode includes a negative current collector, and a negative active material layer placed on the negative current collector, and the negative active material layer includes Si-containing particles and hard carbon as negative active materials. The Si-containing particles are porous bodies containing Si nanoparticles with a network structure. In the secondary battery, the ratio of the average particle diameter D1 of the Si-containing particles to the average particle diameter D2 of the hard carbon (D1/D2) is 0.1 to 0.7, and the weight ratio of the Si-containing particles and the hard carbon is 15:85 to 55:45.

### CROSS REFERENCE TO RELATED APPLICATION

The present application claims priority based on Japanese Patent Application No. 2023-037931 filed on Mar. 10, 2023, the entire contents of which are incorporated in the specification by reference.

### BACKGROUND OF THE DISCLOSURE

### 1. Field

The present disclosure relates to a secondary battery.

### 2. Background

Secondary batteries such as lithium ion secondary batteries have been suitably used for portable power supplies for, for example, personal computers and portable terminals, vehicle driving power supplies for, for example, battery electric vehicles (BEV), hybrid electric vehicles (HEV) and plug-in hybrid electric vehicles (PHEV), and the like. Negative electrodes used for the secondary batteries as described above commonly have a structure in which a negative active material layer including a negative active material is placed on a negative current collector.

In recent years, the use of a Si-based material as a negative active material has been considered for the purpose of, for example, obtaining secondary batteries with a high capacity (e.g., Japanese Unexamined Patent Application Publication No. 2021-38114, WO2022/070895 and Japanese Patent No. 6910296). Japanese Unexamined Patent Application Publication No. 2021-38114 discloses a negative electrode, including a negative active material including a Si-based material, a carbon nanotube with an outermost circumference of 5 nm or less, and carboxymethyl cellulose with a weight average molecular weight of 150000 or more and 450000 or less. WO2022/070895 discloses a silicon material, the precursor of which is amorphous silica generated from a plant raw material. Japanese Patent No. 6910296 discloses a non-graphitizable carbon material for secondary batteries used after being fully charged, in which the amount of oxygen element is 0.25 mass %.

### SUMMARY

Si-based materials have a larger specific capacity than that of carbon materials such as graphite particles, and meanwhile conductive paths tend to be cut due to large expansion and contraction during charging and discharging. Because of this, when using the Si-based material, a high capacity can be obtained, and meanwhile the cycle characteristics of a secondary battery are easily reduced. The results considered by the present inventors found that when using a Si-based material having many voids (pores) to reduce expansion and contraction, the apparent density of a negative active material layer (so-called negative electrode density) tended to be reduced, and an energy density per volume was reduced.

The present disclosure has been made in view of the above points, and an object thereof is to provide a secondary battery, having a negative electrode including a Si-based material and hard carbon as negative active materials, wherein the cycle characteristics and energy density are enhanced.

The secondary battery disclosed herein is a secondary battery, including an electrode body having a positive electrode and a negative electrode, wherein the negative electrode includes a negative current collector, and a negative active material layer placed on the negative current collector, and the negative active material layer includes Si-containing particles and hard carbon as negative active materials. The Si-containing particles are porous bodies containing Si nanoparticles with a network structure. In the secondary battery, the ratio of the average particle diameter D1 of the Si-containing particles to the average particle diameter D2 of the hard carbon (D1/D2) is 0.1 to 0.7, and the weight ratio of the Si-containing particles and the hard carbon is 15:85 to 55:45.

By using the Si-containing particles, which are porous bodies including the Si nanoparticles with a network structure, and the hard carbon, expansion and contraction can be suppressed, and the cycle characteristics of a secondary battery can be enhanced. By adjusting the ratio of the average particle diameter of the Si-containing particles and the average particle diameter of the hard carbon, and the weight ratio of the Si-containing particles and the hard carbon, the negative electrode density can be enhanced, and the energy density per volume can be enhanced. According to the structure, enhancements of the cycle characteristics and the energy density of a secondary battery can be achieved.

### BRIEF DESCRIPTION OF THE DRAWINGS

FIG. 1 is a diagram schematically showing the inner structure of a secondary battery according to one embodiment;

FIG. 2 is a diagram schematically showing the structure of an electrode body according to one embodiment; and

FIG. 3 is a diagram schematically showing a negative electrode according to one embodiment.

### DETAILED DESCRIPTION OF THE PREFERRED EMBODIMENTS

Embodiments of the technique disclosed herein will now be described with reference to drawings. It should be noted that things other than matters particularly mentioned in the specification, which are necessary to implement the technique disclosed herein (for example, general structures and production processes for secondary batteries which do not characterize the technique disclosed herein) can be understood as design matters of those skilled in the art based on conventional techniques in the art. The technique disclosed herein can be implemented based on the contents disclosed in the specification and technical knowledge in the art. It should be noted that each diagram is schematically drawn, and dimensions (e.g., length, width and thickness) do not necessarily reflect actual dimensions. In the diagrams described below, the same sign is provided to members and sites having the same actions, and duplicate descriptions may be omitted or simplified. In addition, the expression of “A to B (A and B are optional values)” showing a range in the specification means “A or more and B or less.”

It should be noted that the “secondary battery” in the specification means a battery in which charging and discharging can be repeated by the movement of a charge carrier between positive and negative electrodes. In the specification the “lithium ion secondary battery” means a secondary battery, in which lithium ion is used as a charge carrier, and charging and discharging are achieved by the movement of the electric charge with lithium ion between positive and negative electrodes.

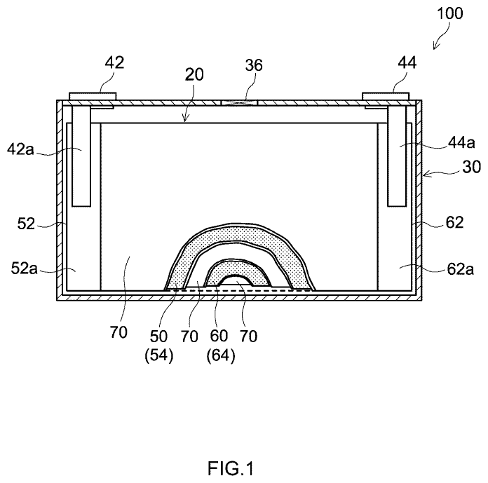

FIG. 1 is a diagram schematically showing the inner structure of a secondary battery 100 according to one embodiment. As shown in FIG. 1, the secondary battery 100 includes an electrode body 20 having a positive electrode 50 and negative electrode 60, an electrolyte solution (not shown), and a battery case 30 to hold the electrode body 20 and the electrolyte solution. The secondary battery 100 shown in FIG. 1 is a lithium ion secondary battery here. The negative electrode 60 disclosed herein is preferably used as a negative electrode for lithium ion secondary batteries.

The battery case 30 has a positive terminal 42 and a negative terminal 44 for external connection, and a thin-walled safety vent 36 set to, when the inner pressure of the battery case 30 is raised to a predetermined level or more, release the inner pressure. The battery case 30 also has an inlet to inject a nonaqueous electrolyte solution (not shown). The positive terminal 42 is electrically connected to a positive current collecting plate 42a. The negative terminal 44 is electrically connected to a negative current collecting plate 44a. As the material of the battery case 30, a metal material which is light and has good thermal conductivity such as aluminum is used.

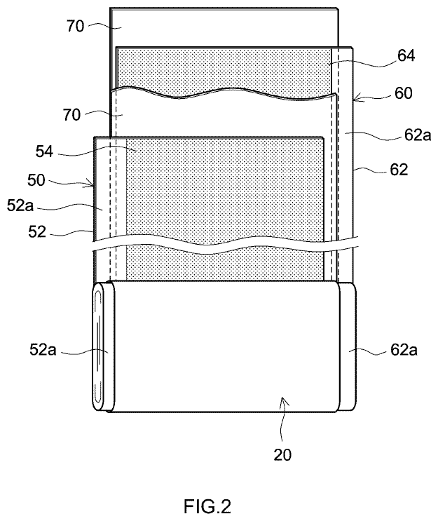

FIG. 2 is a diagram schematically showing the structure of the electrode body 20. The electrode body 20 here is a flat-shaped wound electrode body. As shown in FIG. 2, the electrode body 20 has a form in which a long sheet-shaped positive electrode 50 (hereinafter also referred to as “positive electrode sheet 50”) and a long sheet-shaped negative electrode 60 (hereinafter also referred to as “negative electrode sheet 60”) are laminated with two long separators 70 each between the electrodes, and they are wound in the longitudinal direction. The positive electrode sheet 50 has a structure in which a positive active material layer 54 is formed along the longitudinal direction on one surface or both surfaces of a long positive current collector 52 (both surfaces here). The negative electrode sheet 60 has a structure in which a negative active material layer 64 is formed along the longitudinal direction on one surface or both surfaces of a long negative current collector 62 (both surfaces here). As shown in FIG. 1 and FIG. 2, a positive current collector exposed part 52a (that is, a part in which the positive active material layer 54 is not formed and the positive current collector 52 is exposed), and a negative current collector exposed part 62a (that is, a part in which the negative active material layer 64 is not formed and the negative current collector 62 is exposed) are formed to project outward from both ends of the electrode body 20 in the winding axis direction (that is, the sheet width direction perpendicular the longitudinal direction). The positive current collecting plate 42a and the negative current collecting plate 44a are joined to the positive current collector exposed part 52a and the negative current collector exposed part 62a, respectively.

The positive current collector 52 forming the positive electrode sheet 50 is not particularly limited, and a known positive current collector used for lithium ion secondary batteries may be used. Examples thereof can include sheets or foil made of metal having favorable conductive properties (e.g., aluminum, nickel, titanium and stainless steel). The positive current collector 52 is preferably aluminum foil. The dimensions of the positive current collector 52 are not particularly limited, and may be appropriately determined depending on battery designs. When aluminum foil is used as the positive current collector 52, the thickness thereof is not particularly limited, and is, for example, 5 μm or more and 35 μm or less, and preferably 7 μm or more and 20 μm or less.

The positive active material layer 54 contains a positive active material. As the positive active material, a positive active material having known composition used for lithium ion secondary batteries may be used. As the positive active material, specifically, for example, lithium composite oxides, lithium transition metal phosphate compounds (e.g., lithium iron phosphate (LiFePO₄) and lithium manganese phosphate (LiMnPO₄)) and the like may be used. The crystal structure of the positive active material is not particularly limited, and may be a layer structure, a spinel structure, an olivine structure, or the like.

The lithium composite oxide is preferably a lithium transition metal composite oxide including at least one of Ni, Co and Mn as a transition metal element, and specific examples thereof include lithium nickel composite oxides, lithium cobalt composite oxides, lithium manganese composite oxides, lithium nickel manganese composite oxides, lithium nickel cobalt manganese composite oxides, lithium nickel cobalt aluminum composite oxides, lithium iron nickel manganese composite oxides and the like. These positive active materials may be used individually or two or more of them may be used in combination. Among these, lithium nickel cobalt manganese composite oxides can be preferably used as the positive active material.

It should be noted that the “lithium nickel cobalt manganese composite oxides” in the specification is a term including oxides having Li, Ni, Co, Mn and O as constituent elements, and further encompassing oxides including one or two or more additional elements in addition to the above. Examples of such additional elements include transition metal elements and typical metal elements such as Mg, Ca, Al, Ti, V, Cr, Y, Zr, Nb, Mo, Hf, Ta, W, Na, Fe, Zn and Sn and the like. The additional elements may be also metalloid elements such as Y/Z, Si and P, and nonmetal elements such as S, F, Cl, Br and I. The same applies to the lithium nickel composite oxides, lithium cobalt composite oxides, lithium manganese composite oxides, lithium nickel manganese composite oxides, lithium nickel cobalt aluminum composite oxides, lithium iron nickel manganese composite oxides and the like.

From the viewpoint of obtaining the secondary battery 100 with a high capacity and reducing the amount of CO₂ emission when producing the secondary battery 100, a positive active material having a larger amount of Ni and a smaller amount of Co is preferably used, but the present disclosure is not particularly limited thereto. A composite oxide including at least Li and Ni, in which the amount of Ni is 70 mol % to 100 mol % (more preferably 70 mol % to 90 mol %) and the amount of Co is 5 mol % or less (more preferably 3 mol % or less) to the sum (total mol) of metal elements except for Li, for example, is preferably used.

The positive active material layer 54 may also include components other than the positive active material such as a conductive material and a binder. As the conductive material, for example, carbon black such as acetylene black (AB); carbon fibers such as vapor grown carbon fiber (VGCF) and carbon nanotube (CNT); other carbon materials (e.g., graphite) can be suitably used. As the binder, for example, polyvinylidene difluoride (PVdF) and the like can be used.

The proportion of the conductive material is not particularly limited, and is preferably 0.1 parts by weight or more and 10 parts by weight or less, and more preferably 1 part by weight or more and 5 parts by weight or less when the weight of the positive active material is 100 parts by weight. The proportion of the binder is also preferably 0.1 parts by weight or more and 10 parts by weight or less, and more preferably 1 part by weight or more and 5 parts by weight or less when the weight of the positive active material is 100 parts by weight.

The thickness per surface of the positive active material layer 54 is not particularly limited, and is, for example, 20 μm or more, and preferably 50 μm or more. Meanwhile, the thickness is, for example, 300 μm or less, and preferably 200 μm or less.

As the separator 70, various microporous sheets which have been conventionally used can be used, and examples thereof can include a microporous resin sheet including a resin such as polyethylene (PE) or polypropylene (PP). Such microporous resin sheet may have a single layer structure or a multi-layer structure having two or more layers (e.g., a three layer structure in which a PP layer is laminated on both surfaces of a PE layer). The separator 70 may also include a heat resistance layer (HRL).

As the electrolyte, those which have been conventionally used can be used, and a nonaqueous electrolyte solution obtained by adding a supporting salt in an organic solvent (nonaqueous solvent), for example, can be used. As the nonaqueous solvent, aprotic solvents such as carbonates, esters and ethers can be used. Among these, carbonates such as ethylene carbonate (EC), diethyl carbonate (DEC), dimethyl carbonate (DMC), ethylmethyl carbonate (EMC) and the like, for example, can be suitably adopted. Alternatively, fluorine-based solvents, e.g., fluorinated carbonates such as monofluoroethylene carbonate (MFEC), difluoroethylene carbonate (DFEC), monofluoromethyl difluoromethyl carbonate (F-DMC), trifluorodimethyl carbonate (TFDMC) and the like can be preferably used. These nonaqueous solvents can be used individually, or two or more of them can be used in appropriate combination. From the viewpoint of reducing the amount of CO₂ emission when producing the secondary battery 100, DMC and EC derived from CO₂ are preferably used, but the present disclosure is not particularly limited thereto. As the supporting salt, for example, a lithium salt such as LiPF₆, LiBF₄ or LiClO₄ can be suitably used. The concentration of the supporting salt is not particularly limited, and is preferably about 0.7 mol/L or more and 1.3 mol/L or less.

It should be noted that the nonaqueous electrolyte may include a component other than the nonaqueous solvent and supporting salt as long as the effect of the present technique is not significantly lost, and can include various additives such as a gas generating agent, a film forming agent, a dispersant and a thickening agent.

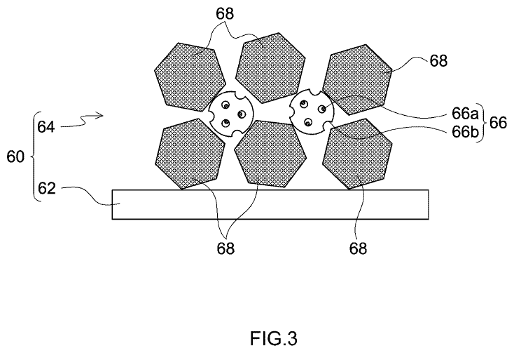

The negative electrode 60 in the secondary battery disclosed herein will now be described. FIG. 3 is a diagram schematically showing the negative electrode 60 in the secondary battery 100 disclosed herein. As shown in FIG. 3, the negative electrode 60 includes the negative current collector 62, and the negative active material layer 64 placed on the negative current collector 62. The negative current collector 62 is not particularly limited, and those which have been conventionally known may be used. Examples thereof include sheets or foil-shaped bodies made of metal such as copper, nickel, titanium or stainless steel. When copper foil is used as the negative current collector 62, the average thickness thereof is not particularly limited, and is, for example, 5 μm or more and 30 μm or less, preferably 5 μm or more and 20 μm or less, and more preferably 5 μm or more and 15 μm or less. From the viewpoint of reducing burden on the global environment, copper foil recycled from copper scrap and the like is preferably used as the negative current collector 62, but the present disclosure is not particularly limited thereto.

The negative active material layer 64 includes at least negative active materials. The negative active material layer 64 includes at least Si-containing particles 66 and hard carbon 68 as the negative active materials. By adjusting the ratio of the average particle diameter (D₅₀ particle size) D1 of the Si-containing particles 66 and the average particle diameter (D₅₀ particle size) D2 of the hard carbon 68, and the weight ratio of the Si-containing particles 66 and the hard carbon 68, enhancements of the cycle characteristics and energy density of the secondary battery 100 can be achieved.

The Si-containing particles 66 are porous bodies including Si nanoparticles 66a with a network structure. The Si-containing particles 66 may include a component other than Si as long as the particles include Si. Examples of the Si-containing particles 66 include SiOx, Si—C composites, Si nanoparticles dispersed in porous Si particles, and the like. The porous body part of the Si-containing particles 66 may be formed, for example, using Si as a main component or using carbon (C) as a main component. As the Si-containing particles 66, for example, a Si—C composite including Si nanoparticles with a network structure and porous carbon particles is preferably adopted. Alternatively, as the Si-containing particles 66, Si particles including Si nanoparticles with a network structure and porous Si particles are preferably adopted. It should be noted that “A is formed using B as a main component” in the specification means that among components forming A, B is the largest component on a weight basis.

The Si-containing particles 66 are porous bodies having a plurality of pores 66b. The Si-containing particles 66 can have, for example, micropores, mesopores and macropores. The micropores, mesopores and macropores here mean pores with a diameter of 2 nm or less, pores with a diameter of above 2 nm and less than 50 nm, and pores with a diameter of 50 nm or more, respectively. When the pore size is too large, there is a risk that the cycle characteristics of the secondary battery 100 will be reduced due to the penetration of an electrolyte solution. From such viewpoint, the size of the pores 66b of the Si-containing particles 66 is preferably, for example, 1 nm or more and 300 nm or less, and may be also 1 nm or more and 250 nm or less. The Si-containing particles 66 can have, for example, a nanoporous structure having a nanosize porous structure.

The Si-containing particles 66 preferably have a plurality of pores 66b with a relatively smaller diameter, but the present disclosure is not particularly limited thereto. Because of this, the expansion and contraction of the Si-containing particles 66 with charging and discharging can be reduced, and the cycle characteristics of the secondary battery 100 can be enhanced. Even when pressing is carried out when producing the negative electrode 60, the Si-containing particles 66 have properties of not easily being crushed due to a plurality of relatively smaller pores 66b. In other words, the Si-containing particles 66 have a plurality of relatively smaller pores 66b, and thus have certain durability. The Si-containing particles 66 include, for example, pores with a diameter of 100 nm or more and pores with a diameter of 10 nm or less. Preferably it has a nanoporous structure in which the pores with a diameter of 10 nm are more than the pores with a diameter of 100 nm. Specifically, the Si-containing particles 66 is preferably adjusted so that the ratio of the log differential pore volume V₁₀ of the pores with a diameter of 10 nm to the log differential pore volume V₁₀₀ of the pores with a diameter of 100 nm (V₁₀/V₁₀₀) will be 1 or more. The ratio of V₁₀ to V₁₀₀ (V₁₀/V₁₀₀) is preferably above 1, more preferably 1.2 or more, and may be also 1.5 or more. The ratio of V₁₀ to V₁₀₀ (V₁₀/V₁₀₀) is also, for example preferably 20 or less, and may be 10 or less.

The log differential pore volume V₁₀₀ of the pores with a diameter of 100 nm, and the log differential pore volume V₁₀ of the pores with a diameter of 10 nm can be calculated based on BJH method using a specific surface area and pore size distribution analyzer. First, the Si-containing particles are heated and dried under vacuum to obtain a measurement sample. Next, the adsorption isotherm of the measurement sample is obtained using liquid nitrogen as a refrigerant and nitrogen gas (N₂ gas) as adsorption gas, and the obtained adsorption isotherm is analyzed by BJH method to obtain log differential pore volume distribution. From the log differential pore volume distribution, the log differential pore volume V₁₀₀ of the pores with a diameter of 100 nm, and the log differential pore volume V₁₀ of pores with a diameter of 10 nm can be obtained.

The Si-containing particles 66 have the Si nanoparticles 66a with a network structure. The Si nanoparticles 66a are nanosize Si particles (i.e., less than 1 μm). The Si nanoparticles 66a can exist on the surface of the porous bodies and/or inside the pores 66b of the porous bodies. The Si nanoparticles 66a are preferably 100 nm or less, and more preferably 50 nm or less. Because of this, the amount of expansion and contraction during charging and discharging per particle of the Si nanoparticles 66a can be reduced, and the particles are not easily broken even when expansion and contraction are repeated. The average particle diameter of the Si nanoparticles 66a is not particularly limited, and can be, for example, 5 nm or more. It should be noted that “the average particle diameter of the Si nanoparticles” in the specification can be obtained as follows. First, by FIB (focused ion beam) processing of the negative active material layer, a sample for scanning transmission electron microscope (STEM) observation is produced. After the elemental analysis of the sample by EDX elemental mapping, BF images (bright field images) and HAADF images (high angle annular dark field images) are taken. From the contrast and shapes obtained from the BF images and the HAADF images, the diameter of the Si nanoparticles can be obtained. The arithmetic mean of diameters of at least 10 Si nanoparticles is considered “the average particle diameter of the Si nanoparticles” here.

The Si nanoparticles 66a have a network structure. In such network structure, a plurality of voids are randomly or regularly formed. Because the Si nanoparticles 66a has a network structure, conductive paths are suitably enhanced. Because the Si nanoparticles 66a have a network structure, excessive expansion and contraction of the Si nanoparticles 66a with charging and discharging are also suppressed.

In the Si-containing particles 66, a plurality of pores 66b preferably exist around the Si nanoparticles 66a, but the present disclosure is not particularly limited thereto. In particular, many pores with a smaller diameter (e.g., pores with a diameter of 10 nm or less) preferably exist around the Si nanoparticles 66a. Because of this, the penetration of the electrolyte solution can be suitably suppressed while reducing expansion and contraction with charging and discharging.

The amount of oxygen in the Si-containing particles is not particularly limited, and is preferably, for example, 10 wt % or less when the total weight of the Si-containing particles is 100 wt %. Because of this, side reactions caused by an excessive amount of oxygen can be reduced, and the capacity and cycle characteristics of the secondary battery can be suitably enhanced. It should be noted that the amount of oxygen can be measured by hot melting in an inert gas using an oxygen analyzer.

The Si-containing particles 66 can be obtained, for example, by burning a Si-containing plant. That is, the Si-containing particles 66 are preferably derived from plants. Specifically, raw materials may be chaff from rice (rice plant), barley, wheat, rye and the like, and plants such as coconut husks, tea leaves, sugar cane and corn. Among these, the Si-containing particles 66 is preferably derived from chaff as a raw material. However, the Si-containing particles 66 may be also prepared by preparing porous bodies formed using Si or C as a main component, and Si nanoparticles with a network structure, and introducing the Si nanoparticles into the porous bodies.

When the Si-containing particles 66 are derived from a plant, finer pores (voids) 66b tend to be more than those when the Si-containing particles are not derived from a plant. It should be noted that by appropriately changing the conditions when burning a plant, the amount of fine pores and the particle diameter of the Si nanoparticles 66a can be adjusted. Si-containing particles 66 having low expansion and high durability are achieved by using Si-containing particles 66 derived from a plant. When the Si-containing particles 66 are derived from a plant, the cycle characteristics of the secondary battery 100 can be further suitably enhanced. In plants, silicic acid absorbed from soil is accumulated around cell walls. By burning this, porous bodies containing plant-derived Si nanoparticles 66a with a network structure can be obtained.

The hard carbon 68 is also referred to as non-graphitizable carbon, and is solid carbon which is not changed to graphite by a heat treatment even at a high temperature of, for example, 3000° C. or more. The hard carbon 68 has smaller crystallites than those of graphite. In addition, the hard carbon 68 has a laminate structure having about several layers of graphene, and also has a turbostratic structure. The hard carbon 68 has a structure which has more pores than those in graphite. Because of this, the hard carbon 68 can reduce expansion and contraction with charging and discharging, and the cycle characteristics of the secondary battery 100 can be enhanced. The hard carbon 68 also has many points in which ions can be inserted and desorbed, and thus the input-output characteristics of the secondary battery 100 tend to be enhanced.

In the hard carbon 68 in the secondary battery 100 disclosed herein, the lattice spacing (d002) of the d(002) plane based on X-ray diffraction (XRD) is preferably 0.37 nm to 0.39 nm. Because of this, ions can be rapidly desorbed and inserted, and the input-output characteristics of the secondary battery 100 are enhanced. Rigidity is also lower than that of graphite, and thus durability against expansion and contraction tends to increase.

The true density of the hard carbon 68 based on the butanol method is not particularly limited, and is preferably 1.4 g/cm³ to 1.7 g/cm³, and more preferably 1.4 g/cm³ to 1.6 g/cm³. When the true density is within the range, low expansion and high durability can be achieved.

The hard carbon 68 as described above can be prepared by an acid treatment of a carbonaceous precursor and then a heat treatment. The hard carbon 68 having a further high capacity can be produced by appropriately changing the conditions of the acid treatment. The carbonaceous precursor here may be a thermoplastic resin such as phenolic resin or may be derived from a plant. The hard carbon 68 is preferably prepared from a plant-derived carbonaceous precursor. The plant-derived carbonaceous precursor is preferably obtained from a plant such as coconut husks, tea leaves, coffee beans or sugar cane as a raw material. Among these, the hard carbon 68 is preferably obtained from coconut husks as a raw material.

When the hard carbon 68 is derived from a plant, a higher capacity is obtained than that of general graphite materials. The plant-derived hard carbon also tends to have a lower true density than that of general graphite materials. The plant-derived hard carbon has smaller expansion during charging and discharging and more excellent durability, and conductive paths are not easily cut. That is, when the plant-derived hard carbon 68 is used, the secondary battery 100 having a high capacity and enhanced cycle characteristics can be achieved.

In the secondary battery 100 disclosed herein, as described above, the cycle characteristics of the secondary battery 100 can be enhanced by using the Si-containing particles 66, which are porous bodies including the Si nanoparticles 66a with a network structure, and the hard carbon 68, having more pores than those of graphite. On the other hand, these materials have relatively more pores (voids), and thus the density when pressing the negative electrode 60 tends to be reduced. In the secondary battery 100 disclosed herein, therefore, a high energy density is achieved by adjusting the ratio of the average particle diameters (D₅₀ particle sizes) and the weight ratio of the Si-containing particles 66 and the hard carbon 68 to predetermined ranges.

In the secondary battery 100 disclosed herein, the ratio of the average particle diameter D1 of the Si-containing particles 66 to the average particle diameter D2 of the hard carbon 68 (D1/D2) is 0.1 to 0.7. The ratio of the average particle diameter D1 to the average particle diameter D2 (D1/D2) is preferably 0.15 to 0.65, and more preferably 0.17 to 0.60. When the ratio of the average particle diameters of the Si-containing particles 66 and the hard carbon 68 is adjusted to the range, the materials are suitably placed when pressing the negative electrode 60, and the energy density can be enhanced.

The average particle diameter (D₅₀ particle size) D1 of the Si-containing particles 66 is not particularly limited as long as the above (D1/D2) is met. For example, the average particle diameter D1 of the Si-containing particles 66 is preferably 2 μm or more and 10 μm or less, and more preferably 2 μm or more and 7 μm or less. The average particle diameter (D₅₀ particle size) D2 of the hard carbon 68 is also not particularly limited as long as the above (D1/D2) is met. For example, the average particle diameter D2 of the hard carbon 68 is preferably 10 μm or more and 25 μm or less, and more preferably 12 μm or more and 20 m or less. It should be noted that “the average particle diameter of the Si-containing particles” and “the average particle diameter of the hard carbon” in the specification mean a particle diameter (D₅₀ particle size) corresponding to the cumulative 50% point from finer particles in the particle size distribution on a volume basis obtained by the particle size distribution measurement based on laser diffraction and light scattering.

In the secondary battery 100 disclosed herein, the weight ratio of the Si-containing particles 66 and the hard carbon 68 is 15:85 to 55:45. From the viewpoint of further enhancing cycle characteristics, it is preferred to increase the proportion of the hard carbon 68 included. For example, the weight ratio of the Si-containing particles 66 and the hard carbon 68 is more preferably 25:75 to 45:55. Because of this, the secondary battery 100 having both cycle characteristics and an enhanced energy density is achieved.

When the apparent density of the negative active material layer 64 (hereinafter, simply referred to as “negative electrode density”) is high, a battery capacity per volume is increased. In other words, the volume energy density is enhanced when the negative electrode density is high. From the viewpoint, the negative electrode density is preferably 1.5 g/cm³ or more, more preferably 1.55 g/cm³ or more, and further preferably 1.58 g/cm³ or more. The upper limit of the negative electrode density is not particularly limited, and is preferably, for example, 2.5 g/cm³ or less. Even in the negative active material layer 64 including the Si-containing particles 66 and the hard carbon 68 as described above, the above negative electrode density can be achieved by adjusting the ratio of the average particle diameters and the weight ratio of the Si-containing particles 66 and the hard carbon 68. It should be noted that the apparent density of the negative active material layer 64 is the ratio of the weight (g) of the negative active material layer 64 to the apparent volume (cm³) of the negative active material layer 64 including voids. The apparent density of the negative active material layer 64 can be calculated, for example, by measuring the basis weight of the negative active material layer 64 and the thickness of the negative active material layer 64 from ((basis weight of negative active material layer 64)/(thickness of negative active material layer 64)).

The negative active material layer 64 may include materials other than the Si-containing particles 66 and the hard carbon 68 (e.g., SiOx which does not have the structure as described above, and graphite particles) as negative active materials as long as the effect of the present technique is not significantly lost.

The amount of the Si-containing particles 66 is not particularly limited, and is preferably 10 wt % or more and 60 wt % or less, more preferably 10 wt % or more and 45 wt % or less, and further preferably 25 wt % or more and 45 wt % or less when the total weight of the negative active materials (the sum of the weight of the Si-containing particles 66, the weight of the hard carbon 68, and the weight of other components which can be included as the negative active materials) is 100 wt %. The amount of the hard carbon 68 is preferably 40 wt % or more and 90 wt % or less, more preferably 65 wt % or more and 90 wt % or less, and further preferably 65 wt % or more and 75 wt % or less when the total weight of the negative active materials is 100 wt %. Enhancements of cycle characteristics and enhancements of the energy density are achieved when the Si-containing particles 66 and the hard carbon 68 are adjusted to the amounts.

In the secondary battery 100 disclosed herein, as described above, the plant-derived Si-containing particles 66 and the plant-derived hard carbon 68 are preferably used. Enhancements of the cycle characteristics and the energy density of the secondary battery 100 can be achieved by adjusting the ratio of the average particle diameters and the weight ratio of the plant-derived Si-containing particles 66 and the plant-derived hard carbon 68. Furthermore, the plant-derived Si-containing particles can be produced at lower temperature and lower electric power than those for Si-containing particles which are not derived from a plant, and thus the amount of CO₂ emission can be reduced. In addition, the plant-derived hard carbon can reduce the CO₂ emission unit price of raw materials compared to the hard carbon which is not derived from a plant. Because of this, the secondary battery 100 having a reduced amount of CO₂ emission of materials can be achieved while enhancing cycle characteristics and obtaining a high energy density.

The negative active material layer 64 may include components other than the negative active materials (Si-containing particles 66 and hard carbon 68) such as a conductive material and a binder. As the conductive material, conventionally known conductive materials can be used. As the conductive material, for example, carbon nanotubes such as single-walled carbon nanotube (SWCNT), double-walled carbon nanotube (DWCNT) and multi-walled carbon nanotube (MWCNT), carbon black such as acetylene black (AB), a carbon fiber and the like can be used. Among these, a carbon nanotube is preferred, and a single-walled carbon nanotube is more preferred. Conductive paths are further suitably maintained by using a carbon nanotube as a conductive material, and the cycle characteristics of the secondary battery 100 can be more suitably enhanced.

The proportion of the conductive material is, for example, 0.01 parts by weight or more and can be 0.05 parts by weight or more when the weight of the negative active materials is 100 parts by weight. The proportion of the conductive material is 2 parts by weight or less and can be 1 part by weight or less, 0.5 parts by weight or less, or 0.2 parts by weight or less when the weight of the negative active materials is 100 parts by weight.

As the binder, conventionally known binders can be used. Examples of the binder include carboxymethyl cellulose (CMC), polyacrylic acid (PAA), styrene butadiene rubber (SBR), polyvinylidene difluoride (PVDF) and the like. Among these, CMC, PAA and SBR can be preferably used. In addition, CMC, PAA and SBR are preferably used in combination, but the present disclosure is not particularly limited thereto.

The entire proportion of the binders is, for example, 1 part by weight or more, preferably 3 parts by weight or more, and more preferably 3.5 parts by weight or more when the weight of the negative active materials is 100 parts by weight. The entire proportion of the binders is also 10 parts by weight or less, preferably 8 parts by weight or less, and more preferably 5 parts by weight or less when the weight of the negative active materials is 100 parts by weight.

The thickness per surface of the negative active material layer 64 is not particularly limited, and is, for example, 20 μm or more, and preferably 50 μm or more. Meanwhile, the thickness is, for example, 300 μm or less, and preferably 200 μm or less.

The proportion of the negative active materials in the whole negative active material layer 64 is not particularly limited, and is, for example, 80 mass % or more, preferably 90 mass % or more, and further preferably 95 mass % or more. The proportion of the negative active materials in the whole negative active material layer 64 is not particularly limited, and may be, for example, 98 mass % or less.

The negative active material layer 64 can be formed by dispersing the Si-containing particles 66 and the hard carbon 68 as the negative active materials, and materials used as needed (e.g., a conductive material and a binder) in a proper solvent (e.g., water) to prepare a paste (or slurry) composition, applying the composition to the surface of the negative current collector 62, and drying the composition. After this, the thickness and the density of the negative active material layer 64 can be adjusted by pressing as needed.

The structure of the negative electrode 60 and the structure of the secondary battery 100 according to one embodiment have been described above. The negative electrode 60 is suitably adopted for nonaqueous electrolyte solution secondary batteries. The negative electrode 60 has high durability against expansion and contraction with repetition of charging and discharging, and the negative electrode density is enhanced when the particle diameter ratio and the weight ratio of the Si-containing particles 66 and the hard carbon 68 are each adjusted. Therefore, the secondary battery 100 having enhanced cycle characteristics and an enhanced volume energy density is achieved. The secondary battery 100 can be employed for various uses, and can be suitably used, for example, as a power source for motors (driving power supply) mounted on vehicles such as cars and trucks. The type of vehicles is not particularly limited, and examples thereof include plug-in hybrid electric vehicle (PHEV), hybrid electric vehicle (HEV), battery electric vehicle (BEV) and the like. The secondary battery 100 can be also suitably used to construct an assembled battery.

In the secondary battery 100, a wound electrode body is exemplified as the electrode body 20, but the electrode body is not limited thereto. A laminated electrode body, for example, may be used in which a plurality of almost rectangular positive electrodes and a plurality of almost rectangular negative electrodes are alternately laminated with separators each between the electrodes.

Test examples of the present disclosure will now be described. It should be noted, however, that the present disclosure is not intended to be limited to the contents described in the following test examples.

### Example 1

First, Si-containing particles (D₅₀ particle size: 5 μm) and hard carbon (D₅₀ particle diameter: 15 μm) were prepared as negative active materials. The Si-containing particles in Example 1 are plant-derived Si—C composite particles from chaff as a raw material. The hard carbon in Example 1 is plant-derived hard carbon from palm shell as a raw material. In addition, single-walled carbon nanotube (SWCNT) was prepared as a conductive material. As binders, carboxymethyl cellulose (CMC), polyacrylic acid (PAA) and styrene butadiene rubber (SBR) were prepared. These were kneaded with water as a solvent so that the weight ratio was hard carbon:Si-containing particles:SWCNT:CMC:PAA:SBR=65:35:0.1:1:1:2 to prepare a negative active material layer-forming slurry.

Specifically, the negative active material layer-forming slurry was mixed and kneaded as follows. First, the Si-containing particles, the hard carbon, CMC and PAA were dry-mixed. Next, the dry-mixed powder, a SWCNT paste (solid content rate 2%), and a dispersion medium were kneaded to a stiff consistency. The solid content rate at the time of solid kneading was 60%. To the mixture subjected to solid kneading, SBR and the solvent (water) were further added, and the obtained mixture was mixed. As described above, a negative active material layer-forming slurry was prepared. This slurry was applied to both surfaces of copper foil (thickness 10 μm) in strips. The slurry on the copper foil was dried, pressed in the condition of a linear pressure of 1.1 kN/cm, and then processed into predetermined dimensions to produce a negative electrode sheet.

Next, lithium nickel cobalt manganese composite oxide (NCM) as a positive active material, acetylene black (AB) as a conductive material, and PVDF as a binder were prepared. These were mixed with N-methyl pyrrolidone (NMP) as a solvent so that the weight ratio was NCM:AB:PVDF=100:1:1, to prepare a positive active material layer-forming slurry. This slurry was applied to both surfaces of aluminum foil (thickness 15 μm) in strips. The slurry on the aluminum foil was dried, pressed to a predetermined thickness, and then processed into predetermined dimensions to produce a positive electrode sheet.

The prepared negative electrode sheet and positive electrode sheet were laminated with a separator between the sheets to produce a laminated electrode body. Current collecting leads were each attached to the positive electrode plate and the negative electrode plate, and the laminated electrode body was inserted into an outer case formed from an aluminum laminate sheet. A nonaqueous electrolyte solution was injected inside the outer case, and the opening of the outer case was sealed to produce an evaluation battery in Example 1. It should be noted that a porous polyolefin sheet having a three layer structure of PP/PE/PP was used as a separator. In addition, a nonaqueous electrolyte solution obtained by mixing ethylene carbonate (EC), fluoroethylene carbonate (FEC), ethylmethyl carbonate (EMC) and dimethyl carbonate (DMC) so that the volume ratio was EC:FEC:EMC:DMC=15:5:40:40, and dissolving LiPF₆ as a supporting salt in the obtained mixed solvent at a concentration of 1 mol/L was used.

### Examples 2 and 3 and Comparative Examples 1 and 2

Evaluation batteries in Examples 2 and 3 and Comparative Examples 1 and 2 were produced in the same manner as in Example 1 except that the weight ratio of the Si-containing particles and the hard carbon was changed as shown in Table 1.

### Examples 4 to 7 and Comparative Example 5

The average particle diameter (D₅₀ particle size) D1 of the Si-containing particles and the average particle diameter (D₅₀ particle size) D2 of the hard carbon were each changed as shown in Table 1. Evaluation batteries in Examples 4 to 7 and Comparative Example 5 were produced in the same manner as in Example 1 except for the above.

### Comparative Example 3

An evaluation battery in Comparative Example 3 was produced in the same manner as in Example 1 except that only the Si-containing particles were used as the negative active material (that is, the hard carbon was not included).

### Comparative Example 4

An evaluation battery in Comparative Example 4 was produced in the same manner as in Example 1 except that only the hard carbon was used as the negative active material (that is, the Si-containing particles were not included).

### <Evaluation of Negative Electrode Density>

The negative electrode density at the time of pressing at a linear pressure of 1.1 kN/cm was calculated. The applied basis weight and thickness of the negative active material layer were measured, and the negative electrode density was calculated from Formula: negative electrode density (g/cm³)=((applied basis weight)/(thickness)). The results are shown in Table 1.

### <Evaluation of Volume Energy Density>

In the first cycle of CCCV charge (at a rate of 0.05 C to 4.2 V and then 0.05 C cut off) and then CC discharge (at a rate of 0.05 C, 2.5 V cut off) under a 25° C. environment, the discharge capacity and the average voltage were obtained. Next, electric energy (Wh) was calculated from Formula: electric energy (Wh)=(discharge capacity)×(average voltage). The electrode body thickness and the electrode body area were also measured, and the electrode body volume (L) was calculated from Formula: electrode body volume (L)=(electrode body thickness)×(electrode body area). The volume energy density (Wh/L) was calculated from Formula: volume energy density (Wh/L)=(electric energy)/(electrode body volume). The results are shown in Table 1.

### <Evaluation of Cycle Capacity Retention Rate>

As one cycle of CCCV charge (at a rate of 0.4 C to 4.2 V and then 0.1 C cut off) and then CC discharge (at a rate of 0.4 C, 2.5 V cut off) under a 25° C. environment, the cycle test was carried out by repeating charging and discharging 250 cycles. The discharge capacity at the first cycle (initial capacity), and the discharge capacity at the 250th cycle were measured, and the cycle capacity retention rate was obtained from Formula: cycle capacity retention rate (%) ((discharge capacity at 250th cycle)/(discharge capacity at first cycle))×100. It can be said that as the cycle capacity retention rate increases, the cycle characteristics of a secondary battery increases. The results are shown in Table 1.

TABLE 1

| | Si-containing particles | | Hard carbon | | | | | | |
|---|---|---|---|---|---|---|---|---|---|
| | | Average | | Average | | | | | |
| | | particle | | particle | Particle | Weight ratio | Negative | Volume | |
| | | diameter | | diameter | diameter | Si-containing | electrode | energy | Capacity |
| | | D1 (D₅₀ | | D2 (D₅₀ | ratio | particles:hard | density | density | retention |
| | Type | particle size) | Type | particle size) | D1/D2 | carbon | (g/cm³) | (Wh/L) | rate (%) |
| Example 1 | Plant-derived Si/C composite | 5 | Plant-derived | 15 | 0.33 | 35:65 | 1.65 | 870 | 88 |
| | particles | | hard carbon | | | | | | |
| Example 2 | Plant-derived Si/C composite | 5 | Plant-derived | 15 | 0.33 | 25:75 | 1.68 | 800 | 90 |
| | particles | | hard carbon | | | | | | |
| Example 3 | Plant-derived Si/C composite | 5 | Plant-derived | 15 | 0.33 | 45:55 | 1.61 | 900 | 83 |
| | particles | | hard carbon | | | | | | |
| Example 4 | Plant-derived Si/C composite | 3 | Plant-derived | 18 | 0.17 | 35:65 | 1.64 | 850 | 89 |
| | particles | | hard carbon | | | | | | |
| Example 5 | Plant-derived Si/C composite | 7 | Plant-derived | 12 | 0.58 | 35:65 | 1.62 | 830 | 87 |
| | particles | | hard carbon | | | | | | |
| Example 6 | Plant-derived Si/C composite | 7 | Plant-derived | 10 | 0.70 | 35:65 | 1.59 | 780 | 86 |
| | particles | | hard carbon | | | | | | |
| Example 7 | Plant-derived Si/C composite | 2 | Plant-derived | 20 | 0.10 | 35:65 | 1.58 | 790 | 85 |
| | particles | | hard carbon | | | | | | |
| Comparative | \|Plant-derived Si/C composite | 5 | Plant-derived | 15 | 0.33 | 5:95 | 1.55 | 600 | 93 |
| Example 1 | particles | | hard carbon | | | | | | |
| Comparative | Plant-derived Si/C composite | 5 | Plant-derived | 15 | 0.33 | 65:35 | 1.20 | 750 | 74 |
| Example 2 | particles | | hard carbon | | | | | | |
| Comparative | Plant-derived Si/C composite | 5 | — | — | — | 100:0 | 0.80 | 590 | less than |
| Example 3 | particles | | | | | | | | 50% |
| Comparative | — | — | Plant-derived | 15 | — | 0:100 | 1.50 | 540 | 96 |
| Example 4 | | | hard carbon | | | | | | |
| Comparative | \|Plant-derived Si/C composite | 10 | Plant-derived | 10 | 1.00 | 35:65 | 1.50 | 710 | 79 |
| Example 5 | particles | | hard carbon | | | | | | |

As shown in Table 1, it is found that the negative electrode density is 1.58 g/cm³ or more, the volume energy density is 780 Wh/L or more, and moreover the capacity retention rate is 80% or more in the evaluation batteries in Examples 1 to 7. From these results, when the Si-containing particles and the hard carbon are included as the negative active materials, the ratio of the average particle diameter D1 of the Si-containing particles to the average particle diameter D2 of the hard carbon (D1/D2) is 0.1 to 0.7, and the weight ratio of the Si-containing particles and the hard carbon is 15:85 to 55:45, a secondary battery having both a high energy density and enhanced cycle characteristics can be achieved.

It is also found that when the ratio of the average particle diameter D1 of the Si-containing particles to the average particle diameter D2 of the hard carbon (D1/D2) is 0.15 to 0.65, the negative electrode density and volume energy density are further enhanced.

As described above, some embodiments of the present disclosure have been described; however, the embodiments are only examples. The present disclosure can be implemented in other various forms. The present disclosure can be implemented based on the contents disclosed in the specification and technical knowledge in the art. Various variants and modifications of the embodiments shown above as examples are encompassed in the techniques described in claims. For example, part of the embodiments can be also replaced with another variant aspect, and another variant aspect can be also added to the embodiments. When technical features are not described as essential, they can be properly removed.

As described above, as specific aspects of the techniques disclosed herein, those described in the following items are provided.

Item 1: A secondary battery, including an electrode body having a positive electrode and a negative electrode, wherein the negative electrode includes a negative current collector, and a negative active material layer placed on the negative current collector, the negative active material layer includes Si-containing particles and hard carbon as negative active materials, the Si-containing particles are porous bodies containing Si nanoparticles with a network structure, the ratio of the average particle diameter D1 of the Si-containing particles to the average particle diameter D2 of the hard carbon (D1/D2) is 0.1 to 0.7, and the weight ratio of the Si-containing particles and the hard carbon is 15:85 to 55:45.

Item 2: The secondary battery according to Item 1, wherein the Si-containing particles and the hard carbon are derived from plants.

Item 3: The secondary battery according to Item 1 or 2, wherein the amount of the Si-containing particles is 10 wt % to 60 wt % when the weight of the negative active materials is 100 wt %.

Item 4: The secondary battery according to any one of Items 1 to 3, wherein the average particle diameter of the Si-containing particles is 2 μm to 10 km.

Item 5: The secondary battery according to any one of Items 1 to 4, wherein the average particle diameter of the hard carbon is 10 μm to 25 km.

What is claimed is:

1. A secondary battery, comprising an electrode body having a positive electrode and a negative electrode,
wherein the negative electrode comprises a negative current collector, and a negative active material layer placed on the negative current collector,
the negative active material layer comprises Si-containing particles and hard carbon as negative active materials,
the Si-containing particles are porous bodies containing Si nanoparticles with a network structure,
a ratio of an average particle diameter D1 of the Si-containing particles to an average particle diameter D2 of the hard carbon (D1/D2) is 0.1 to 0.7, and
a weight ratio of the Si-containing particles and the hard carbon is 15:85 to 55:45.

2. The secondary battery according to claim 1, wherein the Si-containing particles and the hard carbon are derived from plants.

3. The secondary battery according to claim 1, wherein an amount of the Si-containing particles is 10 wt % to 60 wt % when a weight of the negative active materials is 100 wt %.

4. The secondary battery according to claim 1, wherein the average particle diameter of the Si-containing particles is 2 μm to 10 μm.

5. The secondary battery according to claim 1, wherein the average particle diameter of the hard carbon is 10 μm to 25 μm.

6. The secondary battery according to claim 1, wherein the Si-containing particles and the hard carbon are derived from plants,
an amount of the Si-containing particles is 10 wt % to 60 wt % when a weight of the negative active materials is 100 wt %,
the average particle diameter of the Si-containing particles is 2 μm to 10 μm, and
the average particle diameter of the hard carbon is 10 μm to 25 μm.
